(19) United States
(12) Patent Application Publication
(10) Pub. No.: US 2016/0364919 A1
(43) Pub. Date: Dec. 15, 2016

(54) ACCURACY AND EFFICIENCY OF ROAD USER CHARGING

(71) Applicant: International Business Machines Corporation, Armonk, NY (US)

(72) Inventor: Bert J.A. Peeters, Temse (BE)

(21) Appl. No.: 14/970,858

(22) Filed: Dec. 16, 2015

Related U.S. Application Data
(63) Continuation of application No. 14/735,501, filed on Jun. 10, 2015.

(51) Int. Cl. G07B 15/06

(52) U.S. Cl. CPC G07B 15/06

(57) ABSTRACT

In an approach to improving road user charging, a computer retrieves one or more zone records and at least a first zone sequence from a computing device associated with a vehicle, where the one or more zone records include one or more distances traveled by the vehicle. The computer calculates a second zone sequence from the retrieved zone records. The computer compares the first zone sequence to the second zone sequence. The computer determines, based, at least in part, on the comparison of the first zone sequence to the second zone sequence, whether the first zone sequence meets a pre-defined threshold of similarity to the second zone sequence. Responsive to determining the first zone sequence does not meet a pre-defined threshold of similarity to the second zone sequence, the computer retrieves raw location data from the computing device. The computer transmits the raw location data to a precise algorithm.

### BACKGROUND OF THE INVENTION

The present invention relates generally to the field of data processing, and more particularly to improving the accuracy and efficiency of road user charging.

Systems exist for charging fees to users of public roads and public transport. The systems may be used for many different purposes. For example, a system may be used for collecting road tolls, pay-as-you-drive insurance, managing road usage (intelligent transportation systems), tracking fleet vehicle locations, recovering stolen vehicles, providing automatic collision notification, location-driven driver information services and in-vehicle early warning notification alert systems.

Road User Charging (RUC), where the road user is billed for the actual distance traveled, is a method to allocate costs of building and maintaining road infrastructure specifically among those who actually use the road infrastructure, leading to a fair distribution of the burden of the cost among vehicle owners. Modern electronic tolling systems allow for the free-flow of traffic, without stops at barriers; the vehicle is identified electronically, and the vehicle owner receives a charge applied on their account. In a free-flow RUC scheme, vehicle positions are determined using Global Navigation Satellite System (GNSS) navigation technology as a basis of calculating distances. In general, an on board unit (OBU) in the vehicle employs a GNSS system that communicates via a mobile communication connection such as mobile telephony network, e.g., the Global System for Mobile Communications (GSM), to enable information to be relayed to a centralized road tolling apparatus for use in determining a road toll due, or for other purposes.

### SUMMARY

Embodiments of the present invention disclose a method for improving road user charging. The method may include one or more computer processors retrieving one or more zone records and at least a first zone sequence from a computing device associated with a vehicle, where the one or more zone records include one or more distances traveled by the vehicle. The one or more computer processors calculate a second zone sequence from the retrieved zone records. The one or more computer processors compare the first zone sequence to the second zone sequence. The one or more computer processors determine, based, at least in part, on the comparison of the first zone sequence to the second zone sequence, whether the first zone sequence meets a pre-defined threshold of similarity to the second zone sequence. Responsive to determining the first zone sequence does not meet a pre-defined threshold of similarity to the second zone sequence, the one or more computer processors retrieve raw location data from the computing device. The one or more computer processors transmit the raw location data to a precise algorithm.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a sequence labeling algorithm, on a server computer within the distributed data processing environment of FIG. 1, for improving accuracy and efficiency of road usage charging, in accordance with an embodiment of the present invention; and

FIG. 3 depicts a block diagram of components of the server computer executing the sequence labeling algorithm within the distributed data processing environment of FIG. 1, in accordance with an embodiment of the present invention.

### DETAILED DESCRIPTION

A road user charging (RUC) system may be designed to deduce trajectories followed by vehicles from raw location data obtained by a position locator unit within an on board unit (OBU) associated with each vehicle. In such a system, the capability of distance calculation is shared between the position locator unit and a central computation facility. The central computation facility possesses an algorithm that is able to deduce the trajectories with a high level of precision, however the algorithm is relatively costly to run due to the computing resources required. In a number of situations, the position locator units can calculate the trajectories and express a level of confidence with which the trajectories were determined with sufficient accuracy using a less precise, and therefore less costly, algorithm. The central computation facility, however, may choose not to trust the confidence level of the position locator unit, resulting in additional use of the precise algorithm. Embodiments of the present invention recognize that efficiency can be gained by implementing a system where a precise, but costly, algorithm is run when confidence in a less precise algorithm is below a threshold. Implementation of embodiments of the invention may take a variety of forms, and exemplary implementation details are discussed subsequently with reference to the Figures.

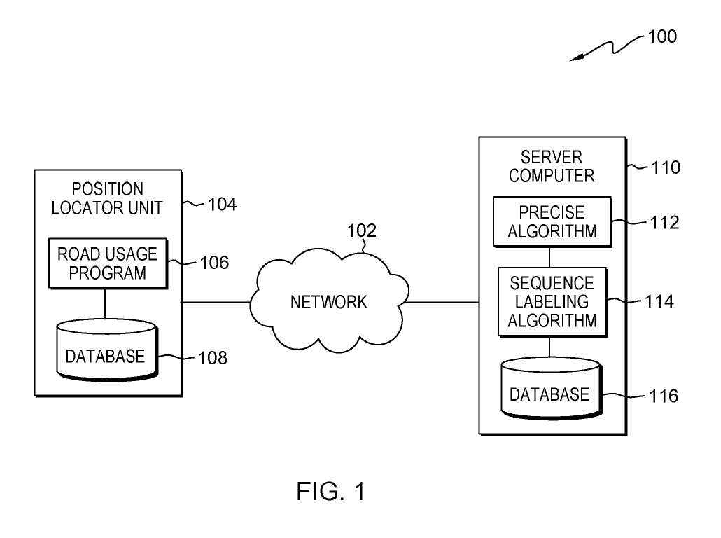

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes position locator unit 104 and server computer 110, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between position locator unit 104, server computer 110, and other computing devices (not shown) distributed data processing environment 100.

Position locator unit 104 can be a laptop computer, a tablet computer, a smart phone, an OBU, or any programmable electronic device capable of communicating with various components and devices within distributed data processing environment 100, via network 102. Position locator unit 104 can be a wearable computer. Wearable computers are miniature electronic devices that may be worn by the bearer under, with or on top of clothing, as well as in glasses, hats, or other accessories. Wearable computers are especially useful for applications that require more complex computational support than just hardware coded logics. In general, position locator unit 104 represents any programmable electronic device or combination of programmable electronic devices capable of executing machine readable program instructions and communicating with other computing devices (not shown) within distributed data processing environment 100 via a network, such as network 102. Position locator unit 104 includes road usage program 106 and database 108.

Road usage program 106 is one of a plurality of computer programs known in the art that detect a location of an associated vehicle and calculate distance traveled. In a geographic location where tariff zones are defined, boundaries of each zone can be expressed as polygon structures, and tariff zones have unique identifiers and associated tariffs or tolls. A zone may contain multiple roads, and there may be one or more places to enter and exit a zone. Each particular zone may include one or more traversal distances that are typical for the zone. The typical traversal distances provide a signature that can characterize through which zone a vehicle travels. Road usage program 106 collects and stores location data of an associated vehicle as the vehicle passes through tariff zones. Location data is raw, positional data calculated using a Global Navigation Satellite System (GNSS). In an embodiment, road usage program 106 retrieves the stored raw location data and judges the accuracy of the raw location data to determine a confidence level. If the confidence level is above a pre-defined threshold, road usage program 106 calculates records associated with zones, referred to as zone records, from the raw location data. In an embodiment, zone records include, but are not limited to, zone identification, time of entry to a zone, time of exit from the zone, distance driven through the zone, and a confidence factor for the accuracy of distance calculations and zone identification. Road usage program 106 creates a collection of zone records that constitute a trip, i.e., travel from geographic location A to geographic location B, which can be referred to as a zone sequence. An individual traversal distance may correspond to a number of different zones, however a sequence of such traversal distances is more likely to correspond with one particular sequence of zones. Road usage program 106 also stores the zone records such that the zone records and zone sequences, in addition to the raw location data, can be made available to server computer 110. Road usage program 106 may either send data directly to server computer 110, or provide access to the data to server computer 110, or both.

Database 108 resides on position locator unit 104. In another embodiment, database 108 can reside elsewhere in the environment provided road usage program 106 has access to database 108. A database is an organized collection of data. Database 108 can be implemented with any type of storage device capable of storing data and configuration files that can be accessed and utilized by position locator unit 104, such as a database server, a hard disk drive, or a flash memory. Database 108 stores raw location data collected by road usage program 106. Database 108 also stores zone records, and associated zone sequences, calculated by road usage program 106. In addition, database 108 stores tariff zone definition data that includes, but is not limited to, the zone identification, zone location, and associated tariffs. In an embodiment, database 108 also stores data related to thresholds for confidence factors of the accuracy of distance calculations and zone identification.

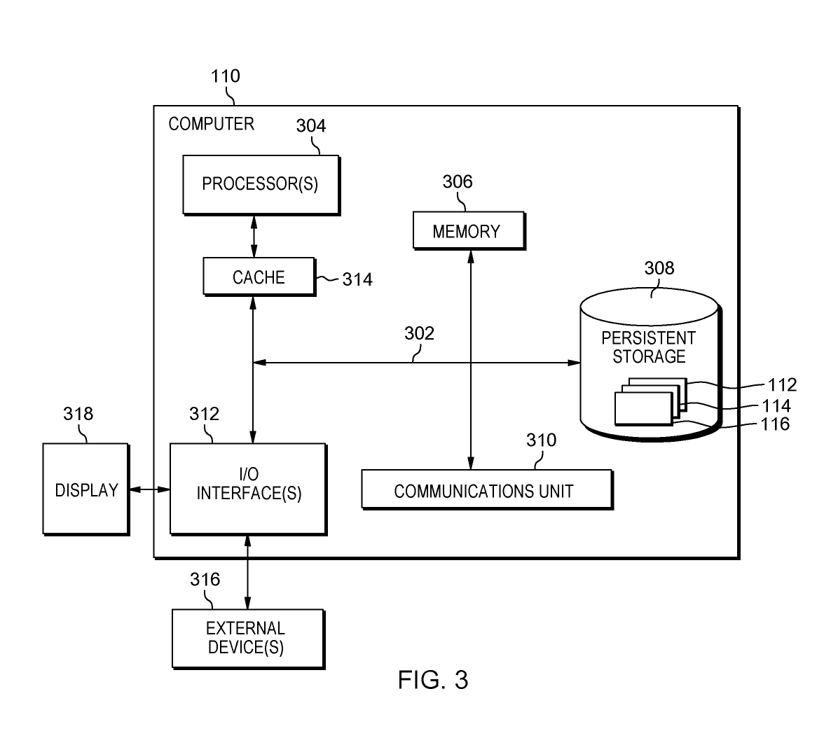

Server computer 110 can be a standalone computing device, a management server, a web server, a mobile computing device, or any other electronic device or computing system capable of receiving, sending, and processing data. In other embodiments, server computer 110 can represent a server computing system utilizing multiple computers as a server system, such as in a cloud computing environment. In another embodiment, server computer 110 can be a laptop computer, a tablet computer, a netbook computer, a personal computer (PC), a desktop computer, a personal digital assistant (PDA), a smart phone, or any programmable electronic device capable of communicating with position locator unit 104 and other computing devices (not shown) within distributed data processing environment 100 via network 102. In another embodiment, server computer 110 represents a computing system utilizing clustered computers and components (e.g., database server computers, application server computers, etc.) that act as a single pool of seamless resources when accessed within distributed data processing environment 100. Server computer 110 includes precise algorithm 112, sequence labeling algorithm 114, and database 116. In various embodiments, server computer 110 also includes a charging application that collects zone records, determines a corresponding tariff, and applies the tariff to a user's account. Server computer 110 may include internal and external hardware components, as depicted and described in further detail with respect to FIG. 3.

Precise algorithm 112 is one of a plurality of computer programs known in the art as map matching algorithms. Map matching algorithms integrate raw GNSS data on to an up-to-date digitized map in order to identify a road segment on which a vehicle travels and calculate distances by adding road segment lengths. Precise algorithm 112 requires a high degree of computing resources, such that precise algorithm 112 is costly to run when compared to less precise algorithms.

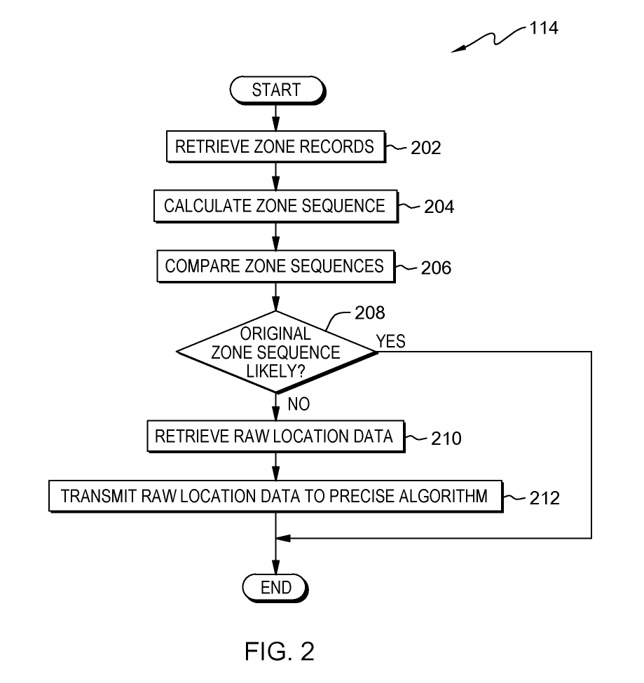

Sequence labeling algorithm 114 reviews zone sequences calculated by road usage program 106 and determines whether the zone sequences are likely. In one embodiment, sequence labeling algorithm 114 determines whether zone sequences are likely as compared to pre-loaded zone transition and zone distance probabilities. Sequence labeling algorithm 114 retrieves a sequence of zone records for a particular vehicle and a particular trip from database 108. Each zone record in the sequence includes an estimated distance the vehicle travels through an associated zone. Using the retrieved distances, sequence labeling algorithm 114 calculates the most likely zone sequence. Sequence labeling algorithm 114 compares the calculated zone sequence to the zone sequence reported by road usage program 106, and determines whether the zone sequences match to within a pre-defined threshold. If the sequences do not match, then sequence labeling algorithm 114 retrieves the raw location data collected by road usage program 106 and stored in database 108, and sends the raw location data to precise algorithm 112 for further processing. Sequence labeling algorithm 114 is depicted and described in further detail with respect to FIG. 2.

Database 116 resides on server computer 110. In another embodiment, database 116 can reside elsewhere in the environment, provided sequence labeling algorithm 114 has access to database 116. Database 116 can be implemented with any type of storage device capable of storing data and configuration files that can be accessed and utilized by server computer 110, such as a database server, a hard disk drive, or a flash memory. Database 116 stores raw location data and zone records, as well as zone sequences calculated by sequence labeling algorithm 114. In an embodiment, database 116 also stores zone transition and zone distance probabilities.

FIG. 2 is a flowchart depicting operational steps of sequence labeling algorithm 114, on server computer 110 within distributed data processing environment 100 of FIG. 1, for improving accuracy and efficiency of road usage charging, in accordance with an embodiment of the present invention.

Sequence labeling algorithm 114 retrieves zone records (step 202). Sequence labeling algorithm 114 retrieves the zone records created by road usage program 106 and stored in database 108 for a completed trip. In an embodiment, road usage program 106 created zone records from raw location data because road usage program 106 judged the accuracy of the location data as adequate for deriving zone records. In embodiments, adequacy is determined based on data pre-loaded within road usage program 106. In one embodiment, road usage program 106 transmits the zone records directly to sequence labeling algorithm 114. Sequence labeling algorithm 114 retrieves the zone records as an original zone sequence, created by road usage program 106. Each zone record includes calculated distances traveled through the corresponding zone, as well as time of entry into the zone and exit out of the zone. In one embodiment, a zone record may also include raw location data. Sequence labeling algorithm 114 stores the retrieved zone records in database 116.

Sequence labeling algorithm 114 calculates a zone sequence (step 204). Sequence labeling algorithm 114 utilizes the data within each zone record to calculate a likely zone sequence. For example, sequence labeling algorithm 114 uses the distance traveled through each zone to calculate a zone sequence. In one embodiment, sequence labeling algorithm 114 may use a Hidden Markov Model (HMM) to derive a likely zone sequence from the data contained in the zone records. In statistics, the HMM is a standard stochastic model for temporal or sequential data. An HMM is used in many applications such as speech recognition, handwriting recognition, part-of-speech (POS) tagging of sentences, etc. HMMs can be considered “sequence annotators.” In the embodiment, the sequence used as input to the model consists of the distances reported by road usage program 106 for the zones that a vehicle (presumably) travels through. The “annotation,” or output of the model, is the zone sequence that most likely corresponds with this sequence of distances. Sequence labeling algorithm 114 stores the zone sequence in database 116.

Sequence labeling algorithm 114 compares zone sequences (step 206). Sequence labeling algorithm 114 compares the original zone sequence, reported by road usage program 106, to the likely zone sequence that sequence labeling algorithm 114 calculated using data from the zone records to determine the level of accuracy of the original zone sequence. For example, sequence labeling algorithm 114 may use a pre-defined threshold of similarity to compare the two zone sequences. In another example, sequence labeling algorithm 114 may look for an exact match between the two sequences.

Sequence labeling algorithm 114 determines whether the original zone sequence is likely (decision block 208). Responsive to comparing the original zone sequence to the calculated zone sequence, sequence labeling algorithm 114 determines whether the likelihood of a trip described by the original zone sequence is below a pre-defined threshold, based on whether the original zone sequence matches the zone sequence calculated by sequence labeling algorithm 114.

If sequence labeling algorithm 114 determines the original zone sequence is not likely (“no” branch, decision block 208), then sequence labeling algorithm 114 retrieves raw location data (step 210). In response to the comparison of the zone sequences, sequence labeling algorithm 114 may come to a different conclusion than road usage program 106 about the sequence of zones that the vehicle drove through, i.e., the zone sequence, and therefore sequence labeling algorithm 114 determines that a more precise calculation is needed. Sequence labeling algorithm 114 retrieves the corresponding raw location data from database 108 and stores the data in database 116.

Sequence labeling algorithm 114 transmits raw location data to a precise algorithm (step 212). Sequence labeling algorithm 114 transmits the retrieved raw location data to precise algorithm 112 for subsequent re-calculation of zone records. In one embodiment, rather than retrieve and transmit the raw location data to precise algorithm 112, sequence labeling algorithm 114 requests road usage program 106 to transmit the raw location data directly to precise algorithm 112. In an embodiment, responsive to precise algorithm 112 re-calculating the zone records, sequence labeling algorithm 114 retrieves and transmits the precise zone records to a charging application. The charging application is responsible for collecting zone records, determining a corresponding tariff, and applying the tariff to a user's account.

If sequence labeling algorithm 114 determines the original zone sequence is likely (“yes” branch, decision block 208), then sequence labeling algorithm 114 ends execution. In an embodiment, responsive to determining the zone sequence originally calculated by road usage program 106 is likely, sequence labeling algorithm 114 transmits the original zone records to a charging application. In another embodiment, responsive to determining the zone sequence originally calculated by road usage program 106 is likely, sequence labeling algorithm 114 requests road usage program 106 to transmit zone records directly to a charging application.

FIG. 3 depicts a block diagram of components of server computer 110 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 110 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., precise algorithm 112, sequence labeling algorithm 114, and database 116 are stored in persistent storage 308 for execution and/or access by one or more of the respective processor(s) 304 of server computer 110 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of position locator unit 104. In these examples, communications unit 310 includes one or more network interface cards. Communications unit 310 may provide communications through the use of either or both physical and wireless communications links. Precise algorithm 112, sequence labeling algorithm 114, and database 116 may be downloaded to persistent storage 308 of server computer 110 through communications unit 310.

I/O interface(s) 312 allows for input and output of data with other devices that may be connected to server computer 110. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., precise algorithm 112, sequence labeling algorithm 114, and database 116 on server computer 110, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for improving a road user charging system, the method comprising:
retrieving, by one or more computer processors, one or more zone records and at least a first zone sequence from a computing device associated with a vehicle, wherein a zone sequence is a collection of one or more zone records associated with a trip, wherein the trip includes travel of the vehicle from a first geographic location to a second geographic location, and wherein the one or more zone records include one or more distances traveled by the vehicle, and wherein the one or more zone records include at least: a zone identification, a time of entry to a zone, a time of exit from the zone, a distance driven through the zone, and a confidence factor for an accuracy of one or more distance calculations and one or more zone identifications;
calculating, by the one or more computer processors, a second zone sequence from the retrieved zone records to derive a zone sequence from data contained in the zone records;
comparing, by the one or more computer processors, the first zone sequence to the second zone sequence;
determining, by the one or more computer processors, based, at least in part, on the comparison of the first zone sequence to the second zone sequence, whether the first zone sequence meets a pre-defined threshold of similarity to the second zone sequence by determining whether the first zone sequence matches the second zone sequence;
responsive to determining the first zone sequence does not meet a pre-defined threshold of similarity to the second zone sequence, retrieving, by the one or more computer processors, raw location data from the computing device, wherein raw location data includes vehicle position data created by a Global Navigation Satellite System;
transmitting, by the one or more computer processors, the raw location data to a precise algorithm for calculation of one or more precise zone records, wherein the precise algorithm is a map matching algorithm; and
responsive to the calculation of one or more precise zone records, transmitting, by the one or more computer processors, the one or more precise zone records to one or more charging applications for determining a corresponding tariff and applying the corresponding tariff to an account.
